(19) United States
(12) Patent Application Publication
(10) Pub. No.: US 2024/0051023 A1
(43) Pub. Date: Feb. 15, 2024

(54) METHOD FOR PRODUCING A BERYLLIUM ARTICLE

(71) Applicant: MATERION CORPORATION, Mayfield Heights, OH (US)

(72) Inventor: Andrew Ruzek, Mayfield Heights, OH (US)

(73) Assignee: MATERION CORPORATION, Mayfield Heights, OH (US)

(21) Appl. No.: 18/448,388

(22) Filed: Aug. 11, 2023

Related U.S. Application Data
(60) Provisional application No. 63/397,163, filed on Aug. 11, 2022.

(51) Int. Cl. B22F 10/28; B22F 10/50; B33Y 10/00; B33Y 40/00

(52) U.S. Cl. CPC B22F 10/28; B22F 10/50; B33Y 10/00; B33Y 40/00; B22F 2998/10; B22F 2301/40

(57) ABSTRACT

Methods for grain refinement of beryllium articles are disclosed. Grain refinement allows the beryllium article to have beneficial properties in terms of strength and durability. The method disclosed herein provide for efficient grain refinement using in situ formed intermetallic compounds of beryllium.

### CROSS REFERENCE TO RELATED APPLICATIONS

This application claims priority to U.S. Provisional Application No. 63/397,163, filed Aug. 11, 2022, which is fully incorporated by reference herein.

### TECHNICAL FIELD

The present disclosure relates to a method for producing a beryllium article. In particular grain refinement of a beryllium article that produces in situ nucleants leading to improved strength and processing.

### BACKGROUND

Beryllium is a metal with highly desirable properties. These include high stiffness (Young's modulus=287 GPa), low density (1.85 g/cc), a high elastic modulus (130 GPa), high specific heat (1925 J/kg K), high thermal conductivity (216 W/m·K), and a low coefficient of linear thermal expansion (11.4×10⁶/° K). As a result, beryllium and its composites are useful in airborne and spaceborne structures, high-performance engines and brakes, and electronic components for thermal performance and vibration damping. Beryllium and its composites are also useful in several different applications, including combustion applications, hypersonic vehicles, computer parts, optics for space- and ground-based systems, satellite structures, solar energy collectors, and nuclear energy growth applications.

One limitation is that casting methods are unsuitable for manufacturing a beryllium product, and lead to columnar solidification. Beryllium is a highly reactive metal with a high melting point, making it susceptible to react with mold-wall materials to form beryllium compounds (BeO, etc.) that become entrapped in the solidified metal. In addition, the grain size is greater than 500 microns and typically much higher up to 50,000 microns. This is far too large to meet strength requirements and results in a brittle material. Further attempts to refine grains through mechanical working have not met with commercial success. To overcome the beryllium production problem, beryllium powder has been used. Beryllium powder can be formed by ball milling, disk grinding, or gas atomizing process. The powder is consolidated into ingots that can be further processed into shaped components of beryllium. This powder process requires careful handling of the beryllium powder. In addition, the powder process has low material utilization that leads to inefficiencies and increased costs. The powder process is also limited in forming complex shapes.

There still remains a need to eliminate columnar solidification for producing beryllium articles having reduced grain size in an efficient manner.

### SUMMARY

The present disclosure relates to methods for making beryllium articles. In one embodiment, the method is for grain refinement of beryllium in an efficient manner that achieves improvements in terms of strength and durability. In one embodiment, the methods disclosed herein provide for efficient grain refinement using in situ formed intermetallic compounds of beryllium. In one embodiment, the intermetallic compounds formed in situ may be a beryllide.

In one embodiment, there is provided a method for producing a beryllium article comprising depositing an initial layer on a surface, the initial layer comprising beryllium and at least one metal selected from the group consisting of iron, zirconium, tantalum, titanium, yttrium, molybdenum, niobium, chromium, nickel, cobalt, hafnium, tungsten, and strontium; forming a plurality of particles comprising an intermetallic compound of beryllium and the at least one metal in the initial layer; inducing beryllium nucleation on a portion, more preferably an exterior portion, of the plurality of particles to form grains having an average grain size from 1 to 40 microns; depositing one or more successive layers on at least a portion of the initial layer opposite of the surface, the one or more successive layers comprising beryllium and at least one metal selected from the group consisting of iron, zirconium, tantalum, titanium, yttrium, molybdenum, niobium, chromium, nickel, cobalt, hafnium, tungsten, and strontium; and repeating the forming and nucleation steps for the one or more successive layers. The initial layer and successive may be deposited in design or pattern to form a complex article of beryllium. In one embodiment, the initial layer may comprises 0.001 to 1.0% by weight of the at least one metal, based on the total weight of the initial layer. In one embodiment, the amount of the at least one metal may be similar in each of the successive layers. Accordingly, the one or more successive layers may comprises 0.001 to 1.0% by weight of the at least one metal, based on the total weight of the one or more successive layer. The intermetallic compounds produced in situ by the method may be a beryllide, such as beryllium titanium (Be₁₂Ti, Be₂Ti), beryllium chromium (Be₂Cr or Be₁₂Cr), iron beryllium (FeBe₅), beryllium zirconium (Be₁₃Zr, Be₅Zr, Zr₂Be₁₇), tantalum beryllide (TaBe₂, Ta₂Be₁₇, TaBe₁₂ or TaBe₁₇), beryllium molybdenum (Be₂Mo, Be₁₂Mo, Be₂₂Mo), or niobium beryllium (NbBe₂, NbBe₃, Nb₂Be₁₇, NbBe₁₂), beryllium tungsten (Be₂₂W), beryllium strontium (Be₁₃Sr), beryllium hafnium (Be₅Hf). In one embodiment, the method exposes the deposited initial layer to an energy source, such as an electron beam or laser, to form the plurality of particles. The method may comprise supplying beryllium in powder form, and preferably the beryllium powder may have a spherical shape. In addition, the method may comprise supplying iron, zirconium, tantalum, titanium, yttrium, molybdenum, niobium, chromium, nickel, cobalt, hafnium, tungsten, or strontium in powder form. The size of the metal powder may be smaller than the beryllium. In one embodiment, the at least one metal remains unreacted prior to being deposited to reduce early formation of intermetallics.

In one embodiment, there is provided a method for producing a beryllium article comprising depositing an initial layer on a surface, the initial layer comprising beryllium and at least one metal selected from the group consisting of iron, zirconium, tantalum, titanium, yttrium, molybdenum, niobium, chromium, nickel, cobalt, hafnium, tungsten, and strontium; directing energy to a portion of the initial layer to form a plurality of particles comprising an intermetallic compound of beryllium in the initial layer; cooling the initial layer; depositing one or more successive layers on at least a portion the initial layer opposite of the surface, wherein the successive layer contains beryllium; directing energy to a portion of the one or more successive layers; and inducing beryllium nucleation on a portion, more preferably an exterior portion, of the plurality of the particles to form grains having an average grain size from 1 to 40 microns. The initial layer and successive may be deposited in pattern to form a complex article of beryllium. In one embodiment, the method may include the at least one metal which functions as the nucleant precursor in the initial layers. Thus, the amount of the at least one metal is reduced in the successive layers. Accordingly, the initial layer may comprises 0.01 to 10% by weight of the at least one metal, while the successive layers comprise reduced amounts of the at least one metal. The intermetallic compounds produced in situ by the method may be a beryllide, such as beryllium titanium (Be₁₂Ti, Be₂Ti), beryllium chromium (Be₂Cr or Be₁₂Cr), iron beryllium (FeBe₅), beryllium zirconium (Be₁₃Zr, Be₅Zr, Zr₂Be₁₇), tantalum beryllide (TaBe₂, Ta₂Be₁₇, TaBe₁₂ or TaBe₁₇), beryllium molybdenum (Be₂Mo, Be₁₂Mo, Be₂₂Mo), or niobium beryllium (NbBe₂, NbBe₃, Nb₂Be₁₇, NbBe₁₂), beryllium tungsten (Be₂₂W), beryllium strontium (Be₁₃Sr), beryllium hafnium (Be₅Hf). In one embodiment, the method exposes the deposited initial layer to an energy source, such as an electron beam or laser, to form the plurality of particles. The method may comprise supplying beryllium in powder form, and preferably the beryllium powder has a spherical shape. In addition, the method may comprise supplying the at least one metal in powder form. The size of the powder for the at least one metal may be smaller than the powder form of beryllium. In one embodiment, the at least one metal remains unreacted prior to being deposit to reduce early formation of intermetallics.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flowchart for an exemplary method to form a beryllium article wherein each layer contains beryllium and at least one metal according to one embodiment of the present invention; and

FIG. 2 is a flowchart for an exemplary method to form a beryllium article wherein the initial layer contains the at least one metal according to one embodiment of the present invention.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions or methods as “consisting of” and “consisting essentially of” the enumerated ingredients/steps, which allows the presence of only the named ingredients/steps, along with any impurities that might result therefrom, and excludes other ingredients/steps.

All ranges disclosed herein are inclusive of the recited endpoint and independently combinable (for example, the range of “from 1 micron to 40 microns” is inclusive of the endpoints, 1 micron and 40 microns, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As described herein, there is a method for producing a beryllium article. One advantage of the methods described herein is the ability to produce articles having complex three-dimensional designs and shapes, material compositions, and desirable mechanical or structural properties. In one embodiment, the method involves forming a plurality of layers in which an intermetallic compound of beryllium is formed in situ. The in situ formation provides a distribution of intermetallic compounds that is beneficial in grain refinement and reduces the need to add the intermetallic compound directly to the each layer. The intermetallic compounds of beryllium act as nucleants for grain refinement. In contrast to the various limitations, drawbacks, and disadvantages associated with known fabrication method for beryllium, the method disclosed herein provides for significant improvements in terms of material composition, energy efficiency, and reduced manufacturing costs.

The methods described herein uses a nucleant precursor material to form intermetallic compounds of beryllium that act as the nucleant to reduce grain growth size. Preferably the intermetallic compounds of beryllium are formed in situ in at least one of the layers of the articles. Accordingly, this is effective in improving the strength of the article and reducing or even eliminating the associated problems with many types of beryllium fabrication methods.

One advantage of the in situ method for forming the nucleant is that grain refiners can be eliminated or reduced. The method described herein forms in situ nucleants to produce grain sizes in a beryllium article that were not previously attainable by prior processes. Accordingly with the reduced grain size the beryllium article has improved properties.

### Materials

The beryllium articles described herein are made from a plurality of layers that include an initial layer and one or more successive layers. In one embodiment, the initial layer comprises beryllium and a nucleant precursor material. The beryllium and nucleant precursor may be deposited separately to form the initial layer or may be blended with the beryllium. In one embodiment, the beryllium is provided as a precursor particle having the unreacted nucleant precursor on the surface of the precursor particle. The precursor particle may have spherical or irregular morphology.

In one embodiment, the nucleant precursor may comprise at least one metal selected from the group consisting of iron, zirconium, tantalum, titanium, yttrium, molybdenum, niobium, chromium, nickel, cobalt, hafnium, tungsten, and strontium. Preferably, the metal be iron, zirconium, tantalum, titanium, molybdenum, niobium, chromium, hafnium, tungsten, and strontium. More preferably, the metal be iron, tantalum, titanium, niobium, or chromium. In some embodiments, there may be a combination of metals used as the nucleant precursor. Preferably, the nucleant precursor remains unreacted while being added and is not formed into an intermetallic compound prior to being deposited.

Accordingly, the initial layer comprises beryllium in an amount from 20 to 99.99% by weight based on the total weight of the initial layer, e.g., from 60 to 99.9% by weight, from 65 to 99.5% by weight, 70 to 99.5% by weight, 75 to 99% by weight, or 80 to 99% by weight. In some embodiments, the initial layer comprises beryllium in an amount of greater than or equal to 95% by weight, e.g., greater than or equal to 96% by weight, greater than or equal to 97% by weight, greater than or equal to 98% by weight, greater than or equal to 99% by weight, or greater than or equal to 99.5% by weight. In some embodiments, the beryllium may be a beryllium alloy such as an aluminum-beryllium or copper-beryllium. High amounts of beryllium in the initial layer may be formed into complex shapes. The amount of the metal or nucleant precursor is relatively less than the beryllium. Effective amounts of the metal for forming the particles are from 0.001 to 1.0% by weight based on the total weight of the initial layer, e.g., from 0.005 to 0.95% by weight, from 0.01 to 0.75% by weight, from 0.025 to 0.5% by weight, or from 0.1 to 0.5% by weight.

In one embodiment, the beryllium includes beryllium powder. Exemplary beryllium metals include S-65 grade (99.2% minimum Be content, 0.9% max BeO), S-200 (98.5% minimum Be content), 0-30 (Hot Isostatically Pressed beryllium, minimum 99% Be content, 0.5% max BeO), and, all available from Materion Corporation. The beryllium powder may have an aspect ratio (mean length to mean width) from 1:1 to 100:1, e.g., from 1:1 to 50:1, from 1:1 to 20:1, from 1:1 to 10:1 or from 1:1 to 5:1. In one embodiment, the beryllium powder may be a spherical shape. The beryllium powder may have an average (D₅₀) particle size from 1 micron to 200 microns, e.g., from 5 microns to 175 microns, from 10 microns to 150 microns, from 15 microns to 100 microns, from 25 microns to 70 microns or from 25 microns to 50 microns. The particle size is the D₅₀, or the diameter at which a cumulative percentage of 50% of the particles by volume is attained. Powders that are smaller than 200 microns show increase tendency to form beryllium articles with reduced grain refinement. When needed, the beryllium powder may be sieved to achieved a desired size.

In one embodiment, the beryllium powder may be in the form of particles having a core-shell structure, with the beryllium making up the core and a continuous or a semi-continuous coating making up the shell. In some embodiments, the continuous or a semi-continuous coating may be the nucleant precursor. Coating the beryllium may be achieved by ball milling, resonance mixing, spray binding, spray drying, laser ablation, electrical-discharge machining, and atomic layer deposition. In some embodiments, the coating includes nickel, either pure nickel or in the form of a nickel alloy. The core may be from 0.1 wt % to 99.9 wt % of the beryllium particles, e.g., from 50 wt % to 99.9 wt % of the beryllium particles, or more preferably from about 92 wt % to less than 100 wt % of the beryllium particles. In some embodiments, the coating may be from 0.1 wt % to 99.9 wt % of the nickel particles, e.g., from 0.1 wt % to 50 wt % of the nickel particles, or more preferably from greater than zero wt % to about 8 wt %. In particular embodiments, the beryllium powder includes from about 92 wt % to less than 100 wt % beryllium and from greater than zero wt % to about 8 wt % nickel. Generally, it is contemplated that the coating forms the particles for grain refinement.

The nucleant precursor, e.g., iron, zirconium, tantalum, titanium, yttrium, molybdenum, niobium, chromium, nickel, cobalt, hafnium, tungsten, and strontium, may also be supplied as a powder. The metal powder may be present as loose powders, a paste, or a suspension that may be blended with beryllium. In one embodiment, the nucleant precursor remains unreacted when added to beryllium. The metal powder may have an aspect ratio (mean length to mean width) from 1:1 to 100:1, e.g., from 1:1 to 50:1, from 1:1 to 20:1, from 1:1 to 10:1 or from 1:1 to 5:1. The metal powder is generally about the same size as the beryllium, although smaller metal powders may be preferred. The metal powder may have an average (D₅₀) particle size of less than 10 microns, e.g., less than 8 microns, less than 5 microns, less than 2.5 microns, less than 2 microns or less than 1 microns. In some embodiments, the metal powder may have an average (D₅₀) that is a nanoparticle, e.g., less than 1 microns. In some embodiment, the nanoparticles may have an average (D₅₀) that is from 10 to 1000 nanometers, e.g., 25 to 950 nanometers, 50 to 900 nanometers, 100 to 800 nanometers, or from 300 to 700 nanometers. Accordingly, the metal powder may have an average (D₅₀) particle size from 0.0001 to 10 microns, e.g., from 0.0005 to 7.5 microns, from 0.001 to 5 microns, from 0.01 to 2.5 microns, or from 0.1 to 1.5 microns. To form the particles for grain refinement, it is preferred that the nucleant precursor is able crystallize prior to the beryllium. In one embodiment, the nucleant precursor may remain crystalline at temperatures above the liquidus temperature of beryllium.

The successive layers used to form the beryllium article may contain beryllium with or without the nucleant precursor. In some embodiments, a portion of the successive layers may contain nucleant precursor. When the successive layers do not contain nucleant precursor, the amount of the nucleant precursor in the initial layer may be from 0.01 to 10% by weight, based on the weight of each successive layer, e.g., from 0.01 to 5% by weight or from 0.01 to 1% by weight.

When a nucleant precursor is included in the successive layers, the beryllium and nucleant precursor may be deposited separately to form successive layers or may be blended together with the beryllium. In one embodiment, the nucleant precursor may comprise at least one metal selected from the group consisting of iron, zirconium, tantalum, titanium, yttrium, molybdenum, niobium, chromium, nickel, cobalt, hafnium, tungsten, and strontium. More preferably, the metal be iron, tantalum, titanium, niobium, or chromium. In some embodiments, there may be a combination of metals used as the nucleant precursor. In one embodiment, the amount of beryllium and the at least one metal may be determined as needed to form the beryllium articles. Thus, the amount of beryllium and the at least one metal may vary in each successive layer. Typically, each successive layer may comprise a range from 20 to 99.99% by weight based on the total weight of the initial layer, e.g., from 60 to 99.9% by weight, from 65 to 99.5% by weight, 70 to 99.5% by weight, 75 to 99% by weight, or 80 to 99% by weight. The amount of the at least one metal ranges from 0.001 to 1.0% by weight, e.g., from 0.005 to 0.95% by weight, from 0.01 to 0.75% by weight, from 0.025 to 0.5% by weight, or from 0.1 to 0.5% by weight. In one embodiment, the successive layer contains less nucleant precursor than the initial layer.

In one embodiment, the successive layers may contain beryllium with little to no nucleant precursors. The amount of the at least one metal is reduced and may be less 0.5% by weight, e.g., less than 0.25% by weight, from 0.01 to 0.75% by weight, from 0.025 to 0.5% by weight, or from 0.1 to 0.5% by weight. The intermetallic compounds of beryllium formed using the nucleant precursors from the initial layer to control grain size in the successive layers.

### Method

Using a combination of the initial and successive layers, a beryllium article may be formed. In one embodiment, the method deposits an initial layer, preferably at a relatively high rate. In one embodiment, the initial layer is uniformly deposited. The beryllium and the nucleant precursor may be supplied separately or homogeneously blended together. When blended together, uniform distribution of nucleant precursors may contribute to the formation of particles suitable for controlling grain refinement. In addition, there may be an optional binder, diluent, or solvent material that can be added separately or together with the beryllium. In some embodiments, the initial layer may be deposited on a surface such as a substrate, platform or base plate. In one embodiment, the initial layer is deposited in a build box. Preferably the powders are transferred to the build box with minimal loss of powder or contamination of the surrounding area. The build box comprises a surface, e.g., build platform, and side walls. The build platform is generally a planar or flat surface on which initial layers and successive layers are deposited. The build platform may move along a vertical z-axis based on signals provided from a computer-operated controller. The side walls cooperate with the build platform to form a “box” that contains the deposited powder. Generally, the side walls remain in a fixed location, and the build platform moves downward to permit the next layer of powder to be deposited.

### Initial Layer

The initial layer may be deposited in a pre-determined pattern on the build surface. In some embodiments, the preset pattern is determined based on the layers of a computer-aided design (CAD) model. Any suitable technique to deposit the initial layer is suitable for the method including spreading, coating, brushing, rolling, spraying, or dispensing. In one embodiment, one or more deposition heads are used and are moved in horizontal x-y plane. A controller may be used to move the one or more deposition heads specified by the design. The horizontal x-y plane is a plane defined by an x-axis and a y-axis where the x-axis, the y-axis, and the z-axis are orthogonal to each other. In some embodiments, the deposition occurs under an inert gas atmosphere.

In one embodiment, the initial layer may be deposited in an even manner. The initial layer may have a thickness from 20 to 200 microns, e.g., from 25 to 150 microns, from 25 to 110 microns, from 30 to 100 microns, from 35 to 75 microns, or from 40 to 60 microns. In some embodiments, the initial layer may be formed by compacting the deposited materials in an optional compaction method. Compacting powders may be desired to provide thin layers using a mechanical compactor such as doctor blades or double rolling or electrostatic force.

Subsequent to the deposition of the initial layer, an energy source may be directed to at least a portion of the initial layer. The energy source may produce localized or focused energy to heat at least a portion of the initial layer. In one embodiment, the energy source may be sufficient to initiate a reaction between the nucleant precursors and beryllium to form the intermetallic compounds of beryllium. The particles of the intermetallic compounds of beryllium are the nucleants for reducing the grain growth size of the beryllium. The energy source may be an electron beam or laser beam having a power density from 10³ W/mm² to 10⁷ W/mm², e.g., from 10⁴ W/mm² to 10⁷ W/mm², or from 10⁵ W/mm² to 10⁶ W/mm². Operating the energy source at a power of less than 10⁷ W/mm² is sufficient to initiate the in situ reaction for producing the nucleants. In addition, a portion of the beryllium may be sintered to the nucleants. In one embodiment, the effective diameter of the energy source may be from 10 to 200 microns, e.g., from 25 to 150 microns, or from 35 to 100 microns. The scanning speed of the energy source may be 10 mm/s to 2000 m/s, e.g., from 50 to 1500 m/s or from 100 to 1000 m/s. The raster width of the energy source may be from 50 to 500 microns, e.g., from 75 to 450 microns, from 75 to 400 microns, or from 100 to 350 microns. In one embodiment, the layer thickness may be from 20 microns to 200 microns, e.g., from 25 microns to 175 microns or from 50 microns to 150 microns. In one embodiment the energy source and/or another source heats the initial layer to a temperature from 20° C. to 800° C., e.g. from 30° C. to 600° C., from 40° C. to 500° C., or from 100° C. to 400° C.

Unless pre-heating is used, the initial layer may be deposited at room temperature (20 to 25° C.). In some embodiments, the deposited initial may be pre-heated in the build box to a temperature of at least 100° C., e.g., at least 120° C., or 150° C., at least 200° C., at least 400° C., at least 450° C., or at least 500° C.

Operating the method under a reduced atmospheric condition or vacuum may provide quality control for the layers and beryllium article material. Nonetheless, in some embodiments, the method may be operated under atmospheric pressure.

In one embodiment, after the initiation of the reaction, the plurality of particles comprising an intermetallic compound of beryllium are formed upon cooling. Cooling of the initial layer allows the particles to form by intermetallic seeding. Minimum cooling rates may be greater than 10° C./min, e.g., greater than 15° C./min or greater than 20° C./min. In some embodiments, the cooling rates may be greater than 1000° C./min, e.g., greater than 10,000° C./min, to achieve rapid solidification. In one embodiment, having sufficient cooling rates may allow for improvements in grain refinement. Various intermetallics may be formed depending on the type and amount of nucleant precursor. In one embodiment, the intermetallic compound of beryllium is a beryllide such as beryllium titanium (Be₁₂Ti, Be₂Ti), beryllium chromium (Be₂Cr or Be₁₂Cr), iron beryllium (FeBe₅), beryllium zirconium (Be₁₃Zr, Be₅Zr, Zr₂Be₁₇), tantalum beryllide (TaBe₂, Ta₂Be₁₇, TaBe₁₂ or TaBe₁₇), beryllium molybdenum (Be₂Mo, Be₁₂Mo, Be₂₂Mo), or niobium beryllium (NbBe₂, NbBe₃, Nb₂Be₁₇, NbBe₁₂), beryllium tungsten (Be₂₂W), beryllium strontium (Be₁₃Sr), beryllium hafnium (Be₅Hf). Once the particles are formed the energy of nucleation of the beryllium is lowered to achieve grain refinement. Thus, beryllium nucleation may be induced on a portion of the intermetallic particles to form grains having small average sizes. In one embodiment, the nucleation may be induced on an exterior portion or surface region of the intermetallic particles. In one embodiment, the average grain size may be from 1 to 40 microns, e.g., from 5 to 25 microns, from 5 to 15 microns, or from 10 to 15 microns.

### Successive Layers

After allowing a sufficient time for particle formation and nucleation, one or more successive layers may be deposited in a pre-determined pattern on at least a portion of the initial layer opposite of the build surface. This continues to build the beryllium article. The successive layers may be deposited at room temperature or may be pre-heated similarly to the initial layer. In a similar manner, an energy source is directed to at least a portion of the successive layer, following by particle formation and inducing beryllium nucleation on a portion of the particles during cooling. In one embodiment, the beryllium nucleation may be induced on the exterior portion or surface of the particles. In one embodiment, the energy source is controlled within similar operating parameters as the initial layer. Depending on the article, the pattern for each successive layer may be different. In some embodiments, the successive may be deposited on at least a portion of the prior or initial layers. In some embodiments, the surface or build plate may be lowered by the thickness of the next successive layer. The thickness of the successive layers may vary and in one embodiment, the successive layer may have a thickness from 20 to 200 microns, e.g., from 25 to 150 microns, from 25 to 110 microns, from 30 to 100 microns, from 35 to 75 microns, or from 40 to 60 microns. In some embodiments, each successive layer may have a similar thickness or the thickness may accommodate the beryllium article.

In one embodiment, the successive layers further comprise the at least one metal and the method may involve forming in situ nucleants in each successive layers. Thus, the grain size is refined in each layer. In other embodiments, the at least one metal is provided in the initial layer and the grain size is refined when the initial and successive layers are heated and cooled.

The method may continue with repeated deposition, heating, and cooling until the desired beryllium article is formed. In one embodiment, the beryllium article may be formed by one or more successive layers, e.g., at least 5 successive layers, at least 10 successive layers, or at least 20 successive layers. For some articles, several hundred layers may be used and thus the number of layers are not limited.

The orientation of the microstructure is not limited to the build direction of the successive layers. The microstructure of the beryllium article may contain a plurality of dendrite layers having differing primary growth-direction angles with respect to each other. This provides for a beryllium article that is crack-free.

In some embodiments, the methods further include curing the plurality of layers prior to sintering the preform. The beryllium article may be annealed for a period from 6 to 12 hours, e.g., from 8 to 10 hours. The annealed article can be finished, for example by polishing or plating. The surface roughness of the article may be reduced, for example, via bead blasting or barrel finishing. In some embodiments, the manufactured beryllium article may have loose or unfused particles in one or more of the layers. The unfused particles may be removed by blowing or vacuuming as needed.

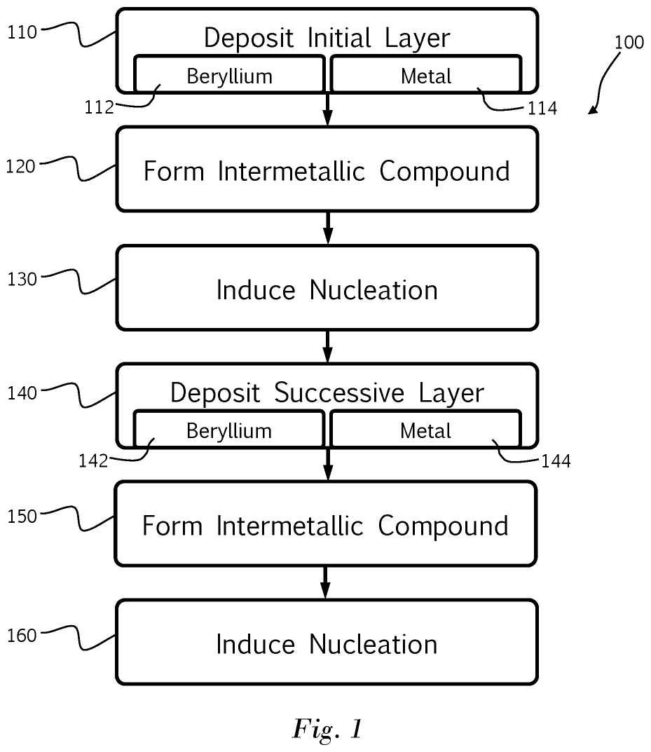

FIG. 1 is a flowchart of an exemplary method 100 to produce a beryllium article. In step 110, an initial layer is deposited on a surface. The initial layer may comprise beryllium 112 and at least one metal 114 selected from the group consisting of iron, zirconium, tantalum, titanium, yttrium, molybdenum, niobium, chromium, nickel, cobalt, hafnium, tungsten, and strontium. Beryllium 112 and the metal 114 may be deposited together or separate. In step 120, an intermetallic compound is formed. The intermetallic compound may be a beryllide and is formed by exposing the deposited initial layer to an energy source. In step 130, beryllium nucleation is induced. The nucleation may be induced on a portion of the particles, e.g., intermetallic compounds. In one embodiment, nucleation is induced on an exterior portion or surface of the particles. Although not shown there may be a cooling step after step 130. In step 140, a successive layer is deposited on the initial layer. The successive layer may comprise beryllium 142 and at least one metal 144 selected from the group consisting of iron, zirconium, tantalum, titanium, yttrium, molybdenum, niobium, chromium, nickel, cobalt, hafnium, tungsten, and strontium. In step 150, an intermetallic compound is formed in the successive layer. The intermetallic compound may be a beryllide and is formed by exposing the deposited initial layer to an energy source. In step 160, beryllium nucleation is induced in the successive layer. The nucleation may be induced on a portion of the particles, e.g., intermetallic compounds. In one embodiment, nucleation is induced on an exterior portion or surface of the particles. The method may continue to repeat steps 140 to 160 to build successive layers as desired to form the beryllium article.

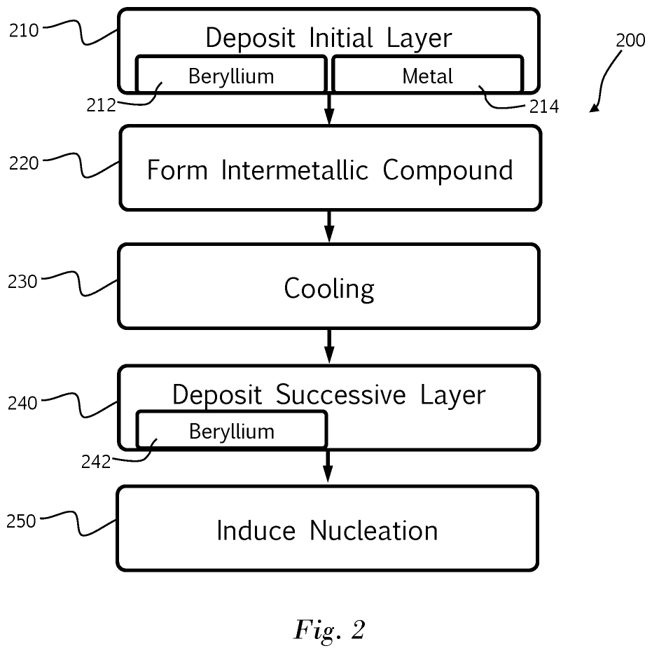

FIG. 2 is a flowchart of an exemplary method 200 to produce a beryllium article. In step 210, an initial layer is deposited on a surface. The initial layer may comprise beryllium 212 and at least one metal 214 selected from the group consisting of iron, zirconium, tantalum, titanium, yttrium, molybdenum, niobium, chromium, nickel, cobalt, hafnium, tungsten, and strontium. Beryllium 212 and the metal 214 may be deposited together or separate. In step 220, an intermetallic compound is formed. The intermetallic compound may be a beryllide and is formed by exposing the deposited initial layer to an energy source. In step 230, the initial layer is cooled. In step 240, a successive layer is deposited on the initial layer. The successive layer may comprise beryllium 242. In one embodiment, it is preferred that the successive layer does not contain any metals since the intermetallic compounds were previously formed in step 220. In step 250, beryllium nucleation is induced in the successive layer. The nucleation may be induced on a portion of the particles, e.g., intermetallic compounds. In one embodiment, nucleation is induced on an exterior portion or surface of the particles. The method may continue to repeat steps 240 and 250 to build successive layers as desired to form the beryllium article.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

What is claimed is:

1. A method for producing a beryllium article comprising:
depositing an initial layer on a surface, the initial layer comprising beryllium and at least one metal selected from the group consisting of iron, zirconium, tantalum, titanium, yttrium, molybdenum, niobium, chromium, nickel, cobalt, hafnium, tungsten, and strontium;
forming a plurality of particles comprising an intermetallic compound of beryllium and the at least one metal in the initial layer;
inducing beryllium nucleation on a portion of the plurality of particles to form grains having an average grain size from 1 to 40 microns;
depositing one or more successive layers on at least a portion of the initial layer opposite of the surface, the one or more successive layers comprising beryllium and at least one metal selected from the group consisting of iron, zirconium, tantalum, titanium, yttrium, molybdenum, niobium, chromium, nickel, cobalt, hafnium, tungsten, and strontium; and
repeating the forming and nucleation steps for the one or more successive layers.

2. The method of claim 1, wherein the initial layer comprises 0.001 to 1.0% by weight of the at least one metal, based on the total weight of the initial layer.

3. The method of claim 1, wherein the one or more successive layers comprises 0.001 to 1.0% by weight of the at least one metal, based on the total weight of the one or more successive layer.

4. The method of claim 1, wherein the intermetallic compound of beryllium comprises a beryllide.

5. The method of claim 1, wherein the forming a plurality of particles occurs by exposing the deposited initial layer to an energy source.

6. The method of claim 1, wherein comprising providing a supply of beryllium in powder form.

7. The method of claim 1, wherein comprising providing a supply of the at least one metal selected in powder form.

8. The method of claim 1, wherein the average grain size is from 5 to 25 microns.

9. A method for producing a beryllium article comprising:
depositing an initial layer on a surface, the initial layer comprising beryllium and at least one metal selected from the group consisting of iron, zirconium, tantalum, titanium, yttrium, molybdenum, niobium, chromium, nickel, cobalt, hafnium, tungsten, and strontium;
directing energy to a portion of the initial layer to form a plurality of particles comprising an intermetallic compound of beryllium in the initial layer;
cooling the initial layer;
depositing one or more successive layers on at least a portion the initial layer opposite of the surface, wherein the successive layer contains beryllium;
directing energy to a portion of the one or more successive layers; and
inducing beryllium nucleation on a portion of the plurality of particles to form grains having an average grain size from 1 to 40 microns.

10. The method of claim 9, wherein the initial layer comprises 0.01 to 10% by weight of the at least one metal.

11. The method of claim 9, wherein the intermetallic compound of beryllium comprises a beryllide.

12. The method of claim 9, wherein the forming a plurality of particles occurs by exposing the deposited initial layer to an energy source.

13. The method of claim 9, wherein comprising providing a supply of beryllium in powder form.

14. The method of claim 9, wherein comprising providing a supply of the at least one metal selected in powder form.

15. The method of claim 9, wherein the average grain size is from 5 to 25 microns.
